(19) United States
(12) Patent Application Publication
(10) Pub. No.: US 2024/0227669 A9
(43) Pub. Date: Jul. 11, 2024

(54) INFORMATION PROCESSING METHOD

(71) Applicant: TOYOTA JIDOSHA KABUSHIKI KAISHA, Toyota-shi (JP)

(72) Inventor: Kenji ISHIYAMA, Kasugai-shi (JP)

(73) Assignee: TOYOTA JIDOSHA KABUSHIKI KAISHA, Toyota-shi (JP)

(21) Appl. No.: 18/488,046

(22) Filed: Oct. 17, 2023

(30) Foreign Application Priority Data
Oct. 21, 2022 (JP) 2022-169475

(51) Int. Cl. B60Q 9/00

(52) U.S. Cl. CPC B60Q 9/00

(57) ABSTRACT

An information processing method by an information processing apparatus capable of communicating with a vehicle designated as a delivery destination of a package, the information processing method includes receiving vehicle information from the vehicle upon detecting an occurrence of a predetermined event regarding a delivery person of the package, determining, based on the vehicle information, whether to operate hazard lamps or a horn of the vehicle, and upon determining to operate the hazard lamps or the horn, transmitting, to the vehicle, a control signal that operates the hazard lamps or the horn.

### CROSS-REFERENCE TO RELATED APPLICATION

This application claims priority to Japanese Patent Application No. 2022-169475, filed on Oct. 21, 2022, the entire contents of which are incorporated herein by reference.

### TECHNICAL FIELD

The present disclosure relates to an information processing method.

### BACKGROUND

Technology for starting actuating horns or alarms of vehicles in cases in which the current position of each of the vehicles is within a predetermined sound generation area after a voice call between an emergency call apparatus and an emergency call center has been terminated is known (e.g., Patent Literature (PTL) 1).

### CITATION LIST

### Patent Literature

PTL 1: JP 2017-222289 A

### SUMMARY

In some vehicle situations, it is not always appropriate to operate horns or alarms.

It would be helpful to reduce the probability of operating hazard lamps or horns in inappropriate situations.

An information processing method according to an embodiment of the present disclosure is an information processing method by an information processing apparatus capable of communicating with a vehicle designated as a delivery destination of a package, the information processing method including:
receiving vehicle information from the vehicle upon detecting an occurrence of a predetermined event regarding a delivery person of the package;
determining, based on the vehicle information, whether to operate hazard lamps or a horn of the vehicle; and
upon determining to operate the hazard lamps or the horn, transmitting, to the vehicle, a control signal that operates the hazard lamps or the horn.

According to an embodiment of the present disclosure, the probability of operating hazard lamps or horns in inappropriate situations can be reduced.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a vehicle;

FIG. 4 is a diagram illustrating a user and the vehicle; and

FIG. 5 is a flowchart illustrating operations of the information processing apparatus.

### DETAILED DESCRIPTION

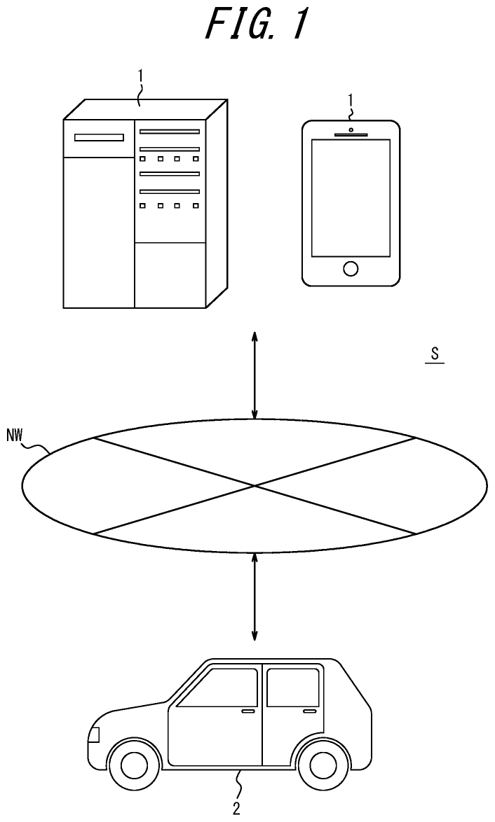

FIG. 1 is a schematic diagram of an information processing system S according to the present embodiment. The information processing system S includes an information processing apparatus 1 and a vehicle 2. The information processing apparatus 1 can communicate with the vehicle 2 via a network NW. The network NW includes, for example, a mobile communication network or the Internet.

FIG. 1 illustrates one of the information processing apparatus 1 and one of the vehicle 2, for convenience of explanation. However, the number of information processing apparatuses 1 and the number of vehicles 2 are not limited to this. For example, processing executed by the information processing apparatus 1 may be executed by a plurality of distributed information processing apparatuses 1.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the vehicle 2. As another alternative example, the information processing apparatus 1 may be a terminal apparatus operated by a delivery person.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

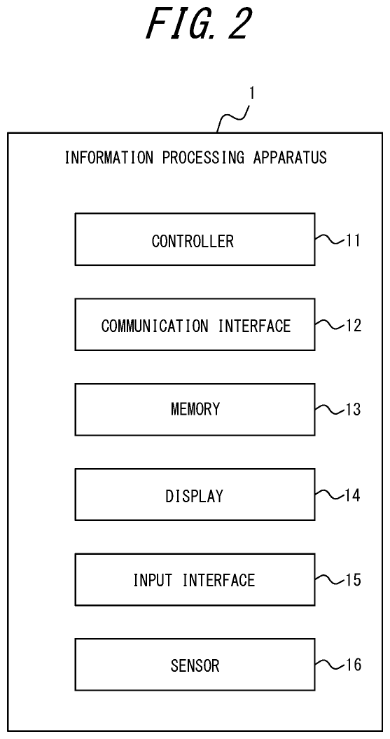

With reference to FIG. 2, an internal configuration of the information processing apparatus 1 will be described in detail.

The information processing apparatus 1 includes a controller 11, a communication interface 12, a memory 13, a display 14, an input interface 15, and a sensor 16. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of dedicated circuits may include a Field-Programmable Gate Array (FPGA) and an Application Specific Integrated Circuit (ASIC). The controller 11 may include an Electronic Control Unit (ECU).

The communication interface 12 includes, for connecting to a network, one or more communication modules that conform to wired or wireless local area network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations or control of the information processing apparatus 1. The memory 13 may store a system program, an application program, embedded software, and the like. The memory 13 may be provided outside the information processing apparatus 1 and accessed by the information processing apparatus 1.

The display 14 is, for example, a display. The display is, for example, an LCD or an organic EL display. The term “LCD” is an abbreviation of liquid crystal display. The term “EL” is an abbreviation of electro luminescence. The display 14 may be connected to the information processing apparatus 1 as an external output device, instead of being included in the information processing apparatus 1. As a connection method, any technology such as USB, HDMI® (HDMI is a registered trademark in Japan, other countries, or both), or Bluetooth® can be used.

The input interface 15 is, for example, a physical key, a capacitive key, a pointing device, a touch screen integrally provided with a display, or a microphone. The input interface 15 accepts an operation for inputting information to be used for the operations of the information processing apparatus 1. The input interface 15 may be connected to the information processing apparatus 1 as an external input device, instead of being included in the information processing apparatus 1. As a connection method, any technology such as USB, HDMI®, or Bluetooth® can be used.

The sensor 16 includes a positional information sensor. The positional information sensor includes at least one GNSS receiver. The term “GNSS” is an abbreviation of global navigation satellite system. GNSS includes, for example, GPS, QZSS, BeiDou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. “Positional information” is information that can identify the position of the vehicle 2, and includes, for example, coordinates.

As an alternative example, the sensor 16 may be a proximity sensor that detects the proximity of an object in a non-contact manner. The sensor 16 may be an image sensor, including a camera. The sensor 16 may be a speed sensor, an acceleration sensor, a direction sensor, or the like.

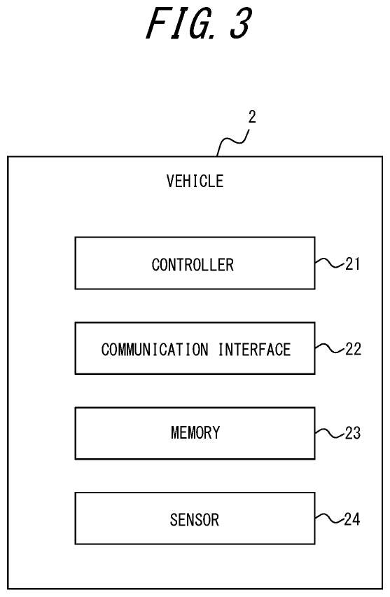

With reference to FIG. 3, an internal configuration of the vehicle 2 will be described in detail.

The vehicle 2 includes a controller 21, a communication interface 22, a memory 23, and a sensor 24. The components of the vehicle 2 are communicably connected to one another, for example, via dedicated lines.

The description of the hardware configurations of the controller 21, the communication interface 22, the memory 23, and the sensor 24 may be the same as the description of the hardware configurations of the controller 11, the communication interface 12, the memory 13, and the sensor 16, respectively. An explanation here is omitted.

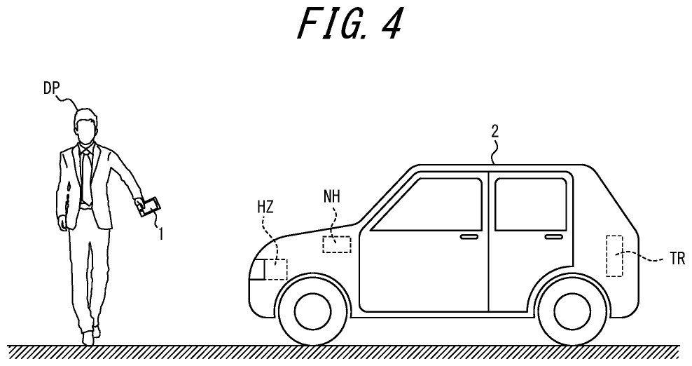

With reference to FIG. 4, processing executed by the information processing system S according to the present embodiment will be described in detail. As an example here, the vehicle 2 is designated as a delivery destination of a package. A delivery person DP delivers the package to a trunk TR or the like of the vehicle 2. The information processing apparatus 1 is operated by the delivery person DP. The Information processing apparatus 1 can communicate with the vehicle 2.

Upon detecting, by the sensor 16 or the like, the occurrence of a predetermined event regarding the delivery person DP of the package, the controller 11 of the information processing apparatus 1 receives vehicle information from the vehicle 2. The event regarding the delivery person DP may be, for example, an event that the delivery person DP has approached the vehicle 2 to a predetermined distance, or an event that the delivery person DP has performed a predetermined request operation. The vehicle information may include information indicating an operation state of an IGN or an ACC, an operation state of an engine, or information indicating whether there is a person in the vehicle 2. The IGN indicates an ignition. The ACC indicates an accessory.

The controller 11 determines, based on the received vehicle information, whether to operate hazard lamps HZ or a horn HN of the vehicle 2. Upon determining to operate the hazard lamps HZ or the horn HN, the controller 11 transmits, to the vehicle 2, a control signal that operates the hazard lamps HZ or the horn HN.

The controller 11 may determine not to operate the hazard lamps HZ or the horn HN in a case in which the IGN or the ACC is turned on, in a case in which the engine is in operation, or in a case in which there is a person in the vehicle 2.

The vehicle information may include positional information on the vehicle 2. In such a case, the controller 11 may determine not to operate the hazard lamps HZ or the horn HN in a case in which the vehicle 2 is determined to be located within an area in which the operation of the hazard lamps HZ or the horn HN is prohibited by law.

Upon determining not to operate the hazard lamps HZ or the horn HN, the controller 11 may notify the delivery person DP of the positional information on the vehicle 2 by screen display or audio. The positional information on the vehicle 2 may be, for example, relative positional information on the vehicle 2 with respect to the delivery person DP (direction and distance from the delivery person), Augmented Reality (AR) display indicating the position of the vehicle 2, or identification information on a parking space for the vehicle 2.

The controller 11 may determine whether to operate the hazard lamps HZ or the horn HN, based on information indicating a state of the delivery person DP in addition to the vehicle information. The controller 11 may determine not to operate the hazard lamps HZ or the horn HN, for example, in a case in which the delivery person DP is on a different floor from the vehicle 2, in a case in which the delivery person DP is facing the opposite direction from the vehicle 2, or the like.

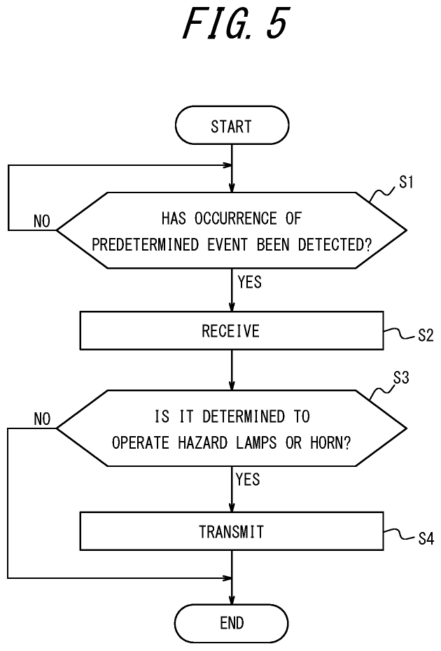

An information processing method performed by the controller 11 of the information processing apparatus 1 will be described with reference to FIG. 5.

In step S1, the controller 11 determines whether the occurrence of a predetermined event regarding a delivery person DP of a package has been detected. If No in step S1, the controller 11 performs step S1 again. If Yes in step S1, the controller 11 receives vehicle information from the vehicle 2 in step S2.

In step S3, the controller 11 determines, based on the vehicle information, whether to operate hazard lamps HZ or a horn HN of the vehicle 2. If No in step S3, the controller 11 does not perform step S4. If Yes in step S3, the controller 11 transmits, in step S4, a control signal that operates the hazard lamps HZ or the horn HN to the vehicle 2.

According to the present embodiment, as described above, the controller 11 performs operations that include receiving vehicle information from the vehicle 2 upon detecting the occurrence of a predetermined event regarding a delivery person DP of a package, determining, based on the vehicle information, whether to operate hazard lamps HZ or a horn HN of the vehicle 2, and upon determining to operate the hazard lamps HZ or the horn HN, transmitting, to the vehicle 2, a control signal that operates the hazard lamps HZ or the horn HN. This configuration allows the information processing apparatus 1 to determine, based on the vehicle information, whether to operate the hazard lamps HZ or the horn HN, thus reducing the probability of operating the hazard lamps HZ or the horn HN in inappropriate situations.

According to the present embodiment, the event regarding the delivery person DP includes, for example, an event that the delivery person DP has approached the vehicle 2 to a predetermined distance, or an event that the delivery person DP has performed a predetermined request operation. This configuration allows the information processing apparatus 1 to receive the vehicle information at appropriate timing.

According to the present embodiment, the vehicle information includes the operation state of an IGN or an ACC, the operation state of an engine, and/or information indicating whether there is a person in the vehicle 2. For example, the controller 11 determines not to operate the hazard lamps HZ or the horn HN in a case in which the IGN or the ACC is turned on, in a case in which the engine is in operation, or in a case in which there is a person in the vehicle 2. This configuration allows the information processing apparatus 1, for example, to reduce the probability of operating the hazard lamps HZ or the horn HN irrespective of a driver's operation in situations in which the driver is present in the vehicle 2. In other words, the information processing apparatus 1 can reduce the probability of misleading the driver into believing that the vehicle 2 is defective.

According to the present embodiment, the vehicle information includes positional information on the vehicle 2. The operations of the controller 11 include determining not to operate the hazard lamps HZ or the horn HN in a case in which the vehicle 2 is determined to be located within an area in which the operation of the hazard lamps HZ or the horn HN is prohibited by law. This configuration allows the information processing apparatus 1 to reduce the probability of operating the hazard lamps HZ or the horn HN in inappropriate situations.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read the program directly from the portable recording medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to the program. For example, data that is not a direct command to a computer but has a property that regulates processing of the computer is “equivalent to a program” in this context.

1. An information processing method by an information processing apparatus capable of communicating with a vehicle designated as a delivery destination of a package, the information processing method comprising:
receiving vehicle information from the vehicle upon detecting an occurrence of a predetermined event regarding a delivery person of the package;
determining, based on the vehicle information, whether to operate hazard lamps or a horn of the vehicle; and
upon determining to operate the hazard lamps or the horn, transmitting, to the vehicle, a control signal that operates the hazard lamps or the horn.

2. The information processing method according to claim 1, wherein the predetermined event regarding the delivery person includes an event that the delivery person has approached the vehicle to a predetermined distance or an event that the delivery person has performed a predetermined request operation.

3. The information processing method according to claim 1, wherein the vehicle information includes an operation state of an ignition or an accessory, an operation state of an engine, and/or information indicating whether a person is in the vehicle.

4. The information processing method according to claim 3, comprising determining not to operate the hazard lamps or the horn in a case in which the ignition or the accessory is turned on, in a case in which the engine is in operation, or in a case in which there is a person in the vehicle.

5. The information processing method according to claim 1, wherein
the vehicle information includes positional information on the vehicle, and
the information processing method comprises determining not to operate the hazard lamps or the horn in a case in which the vehicle is determined to be located within an area in which operation of the hazard lamps or the horn is prohibited by law.
